(19) United States
(12) Patent Application Publication
(10) Pub. No.: US 2020/0356631 A1
(43) Pub. Date: Nov. 12, 2020

(54) SEMANTIC SEQUENCES FOR PROVIDING CONTEXT TO CHARACTERS DISPLAYED VIA A TERMINAL APPLICATION

(71) Applicant: Microsoft Technology Licensing, LLC, Redmond, WA (US)

(72) Inventor: Richard Anthony Beckett Turner, North Bend, WA (US)

(21) Appl. No.: 16/405,428

(22) Filed: May 7, 2019

(51) Int. Cl. G06F 17/27; G06F 3/16

(52) U.S. Cl. CPC G06F 17/2785; G06F 3/167; G06F 17/2705

(57) ABSTRACT

Methods, systems, apparatuses, and computer-readable storage mediums described herein are configured to provide context for characters displayed via a terminal application. For instance, a command line application communicatively coupled to the terminal application may generate a semantic sequence, which includes metadata that provides information about an entity represented by characters that are to be transmitted to the terminal application (via a serialized stream of data) and displayed thereby. The semantic sequence is transmitted to the terminal application via a virtual terminal sequence. The terminal application detects and parses the semantic sequence therein and associates the metadata with characters included in the serialized stream of data. The characters are displayed via the terminal application. The metadata is outputted via an output device in response to user interaction with the characters. The metadata may be output by the terminal application itself or by another application.

### BACKGROUND

From the earliest days of electronic computing, users needed an efficient way to send commands and data to a computer. One of the first truly effective human-computer interfaces was the Tele-Typewriter (“or “Teletype”). Teletypes were electromechanical machines with keyboards for user input and were connected to an output device, such as a printer or a display screen, which displayed output to the user. The program running on the computer would receive characters typed via the Teletype, perform some action based thereon, and might optionally, asynchronously send characters back to the Teletype. The Teletype would print/display the returned characters for the operator to read and respond to.

As technology and transmission speeds increased, Teletypes became obsolete and replaced with terminal devices (or “terminals”) (such as Digital Equipment Corporation's VT100 terminal). Such devices transmit and/or receive data to and/or from a computer using serialized streams of data. For instance, when a user types characters via a keyboard of a terminal device, encoded values (e.g., ASCII values) representing the typed characters are sent to the computer in a serialized fashion.

Aside from outputting text for display and performing some formatting of that text, conventional terminal devices are not capable of conveying any information about what such text actually represents. As such, the end user must infer the meaning of the text from the text itself. This problem is compounded for visually-impaired users, who rely on screen reader applications to audibly read out the text displayed on their display device one character at a time, which to such users, may seem to be a meaningless sequence of letters, numbers, names, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are configured to provide context for characters displayed via a terminal application. For instance, a command line application communicatively coupled to the terminal application may generate a semantic sequence, which includes metadata that provides information about an entity (e.g., a file name, a folder name, a date, etc.) represented by characters (e.g., text) that are to be transmitted to the terminal application (via a serialized stream of data) and displayed thereby. The semantic sequence is transmitted to the terminal application via a virtual terminal sequence included in the stream of data. Upon receiving the virtual terminal sequence, the terminal application detects and parses the semantic sequence therein and associates the metadata with characters included in the serialized stream of data. The characters are displayed by the terminal application (e.g., via a display device). The metadata is outputted via an output device in response to user interaction with the characters (e.g., by hovering a mouse over the characters, pressing a certain key on a keyboard, activating a menu option, etc.). The metadata may be output by the terminal application itself or by another application (e.g., a screen reader application).

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of an example system for providing context to characters displayed via a terminal application in accordance with an example embodiment.

FIG. 2 shows a block diagram of an example system for providing context to characters displayed via a terminal application in accordance with another example embodiment.

FIG. 3 shows an example sequence of characters that comprises a virtual terminal sequence and a semantic sequence in accordance with an example embodiment.

FIG. 4 shows a flowchart of a method for generating and providing a semantic sequence in accordance with an example embodiment.

FIG. 5 shows a block diagram of a command line application in accordance with an example embodiment.

FIG. 6 shows a flowchart of a method for providing context to characters displayed by a terminal application in accordance with an example embodiment.

FIG. 7 shows a block diagram of a system for providing context to characters displayed by a terminal application in accordance with an example embodiment.

FIG. 8 is a block diagram of an exemplary mobile device that may implement embodiments described herein.

FIG. 9 is a block diagram of an example processor-based computer system that may be used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner

### II. Example Implementations

To affect the manner in which text was displayed on terminal devices and to control other aspects of the terminal, such as cursor location and behavior, in-band signaling techniques were introduced, where certain sequences of bytes where embedded with the encoded text values. The sequence of bytes became known as virtual terminal sequences.

Although terminal devices have become increasingly rare, virtual terminal sequences have persisted with emulated terminal applications (i.e., virtual terminal applications) that run on today's computers. This is due to the simplistic and highly portable nature of virtual terminal sequences. They require minimal processing and are understood by most of the computing platforms used today.

However, due to their simplistic nature, conventional terminal applications provide little to zero context with regards to the characters (e.g., text) displayed thereby. To such applications, the text is nothing more than an array of characters. This problem is compounded for visually-impaired users, who rely on screen reader applications (e.g., Windows Narrator) to audibly read out the text displayed on their display device one character at a time.

Embodiments described herein remedy the foregoing problems by providing context for the characters (e.g., text) displayed by a terminal application by leveraging virtual terminal sequences. For instance, a command line application communicatively coupled to a terminal application may generate a semantic sequence, which includes metadata that provides information about an entity (e.g., a file name, a folder name, a date, etc.) represented by characters that are to be transmitted to the terminal application (via a serialized stream of data) and displayed thereby. The semantic sequence is transmitted to the terminal application via a virtual terminal sequence in the stream of data. Upon receiving the virtual terminal sequence, the terminal application detects and parses the semantic sequence therein and associates the metadata with characters included in the serialized stream of data. The characters are displayed by the terminal application (e.g., via a display device). The metadata is outputted via an output device in response to user interaction with the characters (e.g., by hovering a mouse over the characters, pressing a certain key on a keyboard, activating a menu option, etc.). The metadata may be output by the terminal application itself or by another application (e.g., a screen reader application).

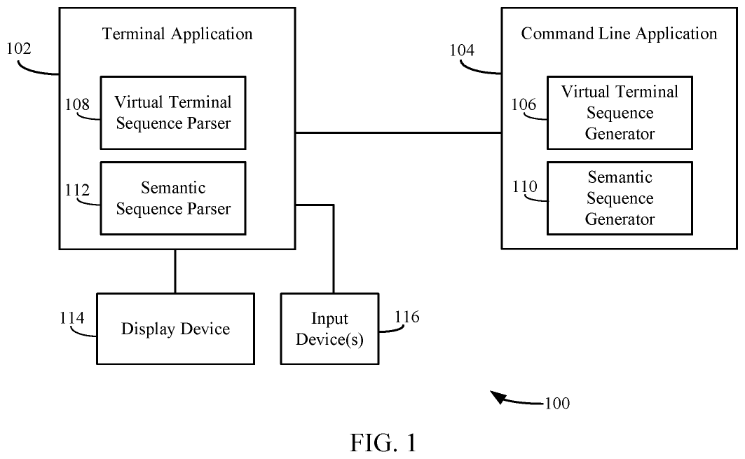

For instance, FIG. 1 shows a block diagram of an example system 100 for providing context to characters displayed via a terminal application 102 in accordance with an example embodiment. As shown in FIG. 1, system 100 includes terminal application 102, a command line application 104, and a display device 114. Terminal application 102 includes a virtual terminal sequence parser 108 and a semantic sequence parser 112. Command line application 104 includes a virtual terminal sequence generator 106 and a semantic sequence generator 110. Terminal application 102 may be configured to receive user input via one or more input devices 116. Examples of input device(s) include, but are not limited to a keyboard, a mouse, a stylus, a light pen, a capacitive touch screen (e.g., incorporated with display device 114), etc. Terminal application 102 may translate user input into one or more characters (e.g., ASCII characters, Unicode characters, and/or the like) and provide the translated characters to command line application 104 as a serialized stream of data. Examples of terminal application 102 include, but are not limited to Windows Console (win32), xterm, Cygwin, and/or the like. Command line application 104 may be configured to receive the translated characters and perform a corresponding action based thereon. For instance, the characters may correspond to one or more commands, parameters, options, and/or the like, entered in by a user via terminal application 102. For instance, the user may type the command ‘dir’ via terminal application 102. Upon receiving this command, command line application 104 may determine a list of a particular directory's files and subdirectories (and/or attributes thereof) and provide the list to terminal application 102 as a serialized stream of data containing displayable characters. The displayable characters may be representative of various entities including, but not limited to a file, a folder, a directory, a subdirectory, a date associated with a file, folder, directory, and/or subdirectory (e.g., a creation date thereof, a last modified date associated therewith, etc.), one or more permissions (e.g., read/write permissions) associated with a file, folder, directory, and/or subdirectory, a size associated with a file, folder, directory, and/or subdirectory, etc. Examples of command line application 104 include, but are not limited, MS-DOS (command com), Windows NT's Command Prompt (cmd.exe), Windows PowerShell, Windows Subsystem for Linux (WSL), Korn shell (ksh), C shell (csh), and Bourne shell (sh), Bourne Again shell (bash), and/or the like.

Upon receiving the serialized stream of data, terminal application 102 may render the displayable characters onto display device 114 coupled to terminal application 102 in the order in which the displayable characters are received.

Other commands may affect the manner in which terminal application 102 displays text. For instance, the user may type the command ‘color <arg1> <arg2>’ (where arg1 represents the background color to be displayed via terminal application 102 and arg2 represents the foreground color to be displayed via terminal application 102). Terminal application 102 may provide the command as a serialized stream of data. Upon receiving the serialized stream of data, command line application 104 may parse the serialized stream of data and determine the command included therein. In response, command line application 104 may provide the command to virtual terminal sequence generator 106, which generates a virtual terminal sequence corresponding to the command The virtual terminal sequence may comprise a non-displayable character (e.g., ‘Esc’), which indicates to terminal application 102 that the received serialized stream of data comprises a virtual terminal sequence. The virtual terminal sequence may further comprise control character sequences, which when processed by terminal application 102, cause terminal application 102 to perform the corresponding command.

Terminal application 102, upon receiving the serialized stream of data, may parse the stream of data. Upon determining that the stream of data includes the non-displayable character, terminal application 102 causes virtual terminal sequence parser 108 to parse the serialized stream of data for control character sequences. Upon detecting a control character sequence, virtual terminal sequence parser 108 causes terminal application 102 to perform the corresponding command For example, virtual terminal sequence parser 108 causes terminal application 102 to change its background and foreground colors in accordance to the control character sequence included in the received serialized stream of data. Any subsequent displayable characters received via the serialized stream of data will be displayed by terminal application 102 in accordance with the background and foreground color until a new virtual terminal sequence (including a new virtual terminal sequence command to change the foreground and background color) is received.

In the event that virtual terminal sequence parser 108 does not recognize the control character sequence, virtual terminal sequence parser 108 ignores the virtual terminal sequence, and terminal application 102 continues to parse the serialized stream of data.

It is noted that a virtual terminal sequence may include other types of commands, including, but not limited to commands to control cursor positioning, cursor behavior, modify and/or format text, etc.

Due to their simplistic nature, conventional terminal applications provide little to zero context with regards to the text displayed thereby. This problem is compounded for visually-impaired users, who rely on screen reader applications (e.g., Windows Narrator) to audibly read out the text displayed on their display device one character at a time.

To remedy this problem, semantic sequence generator 110 may be configured to include metadata in a virtual terminal sequence provided to terminal application 102. The metadata is associated with particular displayable characters also included in the serialized stream of data and provides information about an entity that is represented by the particular displayable characters (e.g., information that provides more context than the displayable characters by themselves). Semantic sequence parser 112 of terminal application 102 may be configured to parse the serialized stream of data to determine the metadata included therein and associate the metadata with the displayable characters in the serialized stream of data. The displayable characters may be rendered on the display device unconditionally, whereas the metadata may be displayed responsive to user input. For example, a user may hover a mouse cursor over certain displayable characters. In response to the cursor hovering over the displayable characters for a predetermined period of time, terminal application 102 may cause the metadata to be rendered on display device 114 (e.g., in a box in proximity to the displayed characters). In another example, the metadata may be provided to another application, such as a screen reader application. The screen reader application may be configured to audibly read the metadata out before, or in lieu of, audibly reading out the displayable characters, thereby providing the user with context as to what is being displayed on the screen.

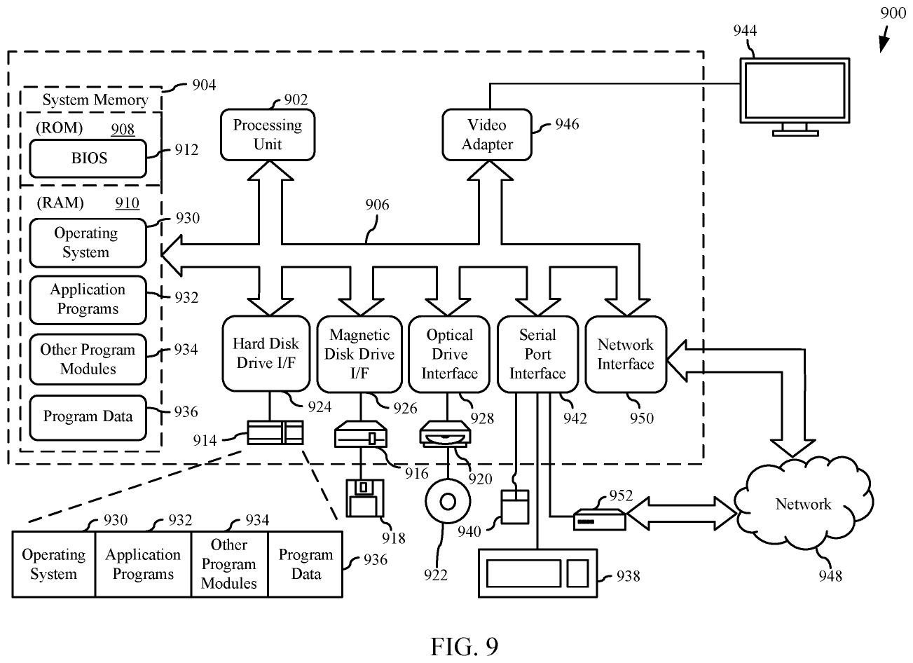

In accordance with an embodiment, both terminal application 102 and command line application 104 execute on the same computing device. In accordance with such an embodiment, terminal application 102 and command line application 104 may be communicatively coupled via application programming interfaces (APIs) and/or input/output control (IOCTL) messages. In accordance with another embodiment, terminal application 102 and command line application 104 execute on different computing devices. In accordance with such an embodiment, terminal application 102 and command line application 104 may be communicatively coupled via a wired or wireless connection. Examples of a wired connection include, but are not limited to, a Universal Serial Bus (USB) cable, a IEEE 1394-based (i.e., Firewire) cable, an external Serial ATA cable, an RJ45 cable, a RS-232 cable, etc. Examples of a wireless connection include, but are not limited to a IEEE 802.11 wireless LAN (WLAN) connection, etc. Examples of such computing devices are described below with reference to FIG. 9.

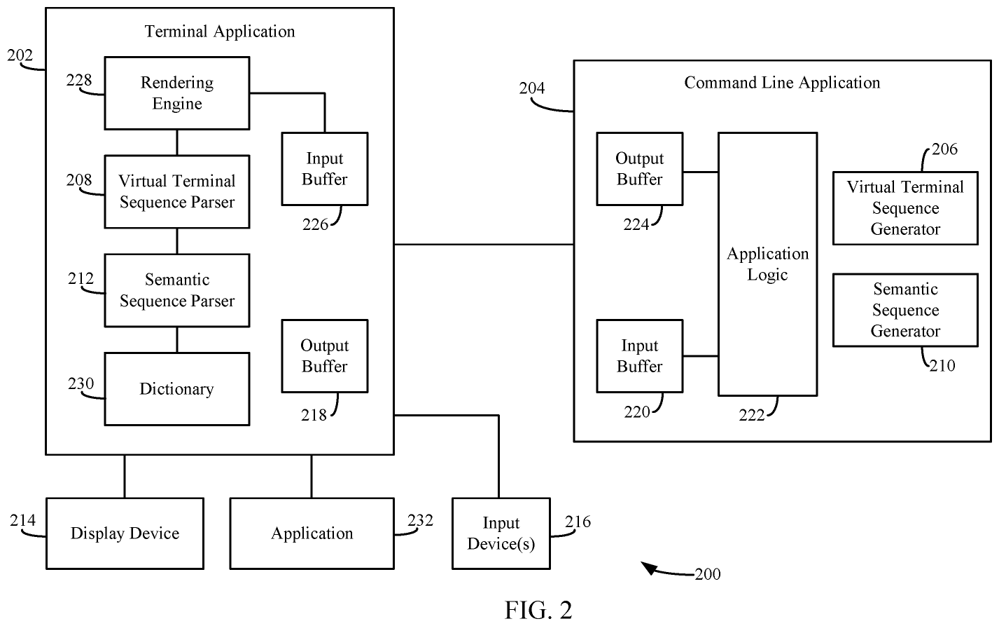

Additional details regarding semantic sequences are described below. For example, FIG. 2 shows a block diagram of an example system 200 for providing context to characters displayed via a terminal application 202 in accordance with another example embodiment. As shown in FIG. 2, system 200 includes terminal application 202 and a command line application 204. Terminal application 202 and command line application 204 are examples of terminal application 102 and command line application 104, as described above with reference to FIG. 1. As also shown in FIG. 2, terminal application 202 is coupled to a display device 214, an application 232, and input device(s) 216. Display device 214 and input device(s) 216 are examples of display device 114 and input device(s) 216, as described above with reference to FIG. 1. As further shown in FIG. 2, terminal application 202 comprises a rendering engine 228, a virtual terminal sequence parser 208, a semantic sequence parser 212, a dictionary 230, an input buffer 226, and an output buffer 218. Command line application 204 may comprise a virtual terminal sequence generator 206, a semantic sequence generator 210, an input buffer 220, application logic 222, and an output buffer 224. Virtual terminal sequence parser 208, semantic sequence parser 212, virtual terminal sequence generator 206, and semantic sequence generator 210 are examples of virtual terminal sequence parser 108, semantic sequence parser 112, virtual terminal sequence generator 106, and semantic sequence generator 110, as described above with reference to FIG. 1.

A user may utilize input device(s) 216 to enter user input, which is received by terminal application 202. The user input (e.g., characters typed by the user) may be encoded in accordance with a computing standard, such as, but not limited to, ASCII, Unicode, and/or the like, and may be buffered in output buffer 218. Output buffer 218 may buffer user input for output as electrical signals to command line application 204. Command line application 204 receives the user input and stores the user input in input buffer 220. Application logic 222 retrieves the user input from input buffer 220, analyzes the user input, and/or performs an action based thereon. For instance, the user input may include a sequence of characters that correspond to commands, parameters, options, and/or the like, entered in by a user via terminal application 202. Upon receiving such input, application logic 222 may determine characters to be provided to terminal application 202 to be displayed thereby.

Application logic 222 may further associate metadata with the characters to be provided to terminal application 202. The foregoing may be accomplished via a virtual terminal sequence. For instance, application logic 222 may cause virtual terminal sequence generator 206 to generate a virtual terminal sequence that indicates to terminal application 202 that the serialized stream of data provided thereto includes a semantic sequence. The semantic sequence may be generated by semantic sequence generator 210. For instance, for a particular string of one or more characters, application logic 222 may issue an application programming interface (API) call to virtual terminal sequence generator 206 and/or semantic sequence generator 210. The API call may specify that a semantic sequence is to be generated, the particular string of characters, and/or an abstracted version of the metadata. In response to receiving the API call, semantic sequence generator 210 generates a semantic sequence that associates the particular displayable characters with the metadata, and virtual terminal sequence generator 206 generates a virtual terminal sequence that includes the semantic sequence. The virtual terminal sequence is stored in output buffer 224, which buffers the virtual terminal sequence for output as a serialized stream of data to terminal application 202.

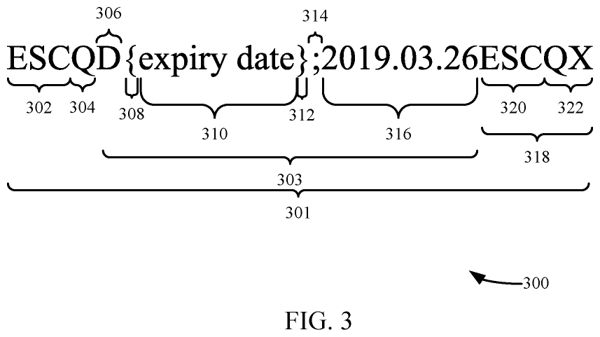

FIG. 3 shows an example sequence of characters 300 that comprises a virtual terminal sequence 301 and a semantic sequence 303 in accordance with an example embodiment. It is noted that while sequence 300 is depicted in a human-readable format, virtual terminal sequence 301 is transmitted by command line application 204 and received by terminal application 202 as an encoded, serialized stream of data. Virtual terminal sequence 301 may be encoded in accordance with a computing standard, such as, but not limited to, ASCII, Unicode, and/or the like.

As shown in FIG. 3, virtual terminal sequence 301 may start with a start indicator 302. Start indicator 302 may comprise a non-displayable control code character that indicates to terminal application 202 that the serialized stream of data received thereby includes a virtual terminal sequence. As shown in FIG. 3, the control code is a non-displayable escape character “ESC”, which corresponds to an ASCII encoding of 0x1B and a Unicode encoding of U+001B. However, it is noted that the usage of the ‘ESC’ character is purely exemplary and that any sequence of one or more non-displayable characters may be used as start indicator 302.

Start indicator 302 may be followed by a sequence of one or more characters that terminal application 202 processes in context with start indicator 302. Such characters are not displayed by terminal application 202, but instead are used to determine the type of virtual terminal sequence. For instance, to indicate virtual terminal sequence 301 comprises a semantic sequence, start indicator 302 may be followed by a first semantic sequence indicator 304. As shown in FIG. 3, first semantic sequence indicator 304 may be a ‘Q’ character, which corresponds to an ASCII encoding of 0s51 and a Unicode encoding of U+0051. However, it is noted that the usage of the ‘Q’ character is purely exemplary and that any sequence of one or more characters may be used as first semantic sequence indicator 304.

First semantic sequence indicator 304 may be followed by a sequence of one or more characters that indicate the category of metadata and/or characters to be displayed by terminal application 202 (e.g., category indicator 306). As shown in FIG. 3, category indicator 306 may be a ‘D’ character, which corresponds to an ASCII encoding of 44 and a Unicode encoding of U+0044. The ‘D’ character may indicate that semantic sequence 303 included in virtual terminal sequence 301 includes a date. However, it is noted that the usage of the ‘D’ character is purely exemplary and that any sequence of one or more characters may be used as category indicator 306 to indicate any number of categories.

Category indicator 306 may be followed by a start metadata indicator 308 that indicates that the characters following start metadata indicator 308 comprise metadata. As shown in FIG. 3, start metadata indicator 308 may be a ‘{’ character, which corresponds to an ASCII encoding of 0x7B and a Unicode encoding of U+007B. However, it is noted that the usage of the ‘{’ character is purely exemplary and that any sequence of one or more characters may be used as start metadata indicator 308.

Start metadata indicator 308 may be followed by metadata 310, which may comprise a sequence of displayable characters. For example, as shown in FIG. 3, metadata 310 corresponds to displayable characters “expiry date”.

End metadata indicator 312 may indicate that the sequence of metadata 310 included in semantic sequence 303 has completed. As shown in FIG. 3, end metadata indicator 312 may be a ‘}’ character, which corresponds to an ASCII encoding of 0x7D and a Unicode encoding of U+007D. However, it is noted that the usage of the ‘}’ character is purely exemplary and that any sequence of one or more characters may be used as end metadata indicator 312.

End metadata indicator 312 may be followed by a delimiter 314. For terminal applications that are compatible with semantic sequence 303 (i.e., capable of recognizing semantic sequences), such as terminal application 202), delimiter 314 causes terminal application 202 to associate metadata 310 with displayable characters included in virtual terminal sequence 301. For instance, as shown in FIG. 3, sequence 300 comprises displayable characters 316 (“2019.03.26”), which correspond to a date (as specified by category indicator 306). Terminal application 202 associates metadata 310 with displayable characters 316 using delimiter 314. For terminal applications that are not compatible with semantic sequences, delimiter 314 may indicate an end of the virtual terminal sequence. Accordingly, such terminal applications may attempt to interpret virtual terminal sequence 301 until it receives delimiter 314. Because such terminal applications are incompatible with semantic sequences, such terminal applications will not be able to properly interpret the virtual terminal sequence, ignore (or drop) virtual terminal sequence, and proceed with processing the remaining portions of sequence 300, as if they were not part of virtual terminal sequence 301. In the example shown in FIG. 3, such terminal applications display displayable characters 316 and ignore start indicator 302, first semantic sequence indicator 304, category indicator 306, start metadata indicator 308, metadata 310, and end metadata indicator 312. It is noted that the usage of the ‘;’ character is purely exemplary and that any sequence of one or more characters may be used as delimiter 314.

Displayable characters 316 may be followed by an end indicator 318. End indicator 318 may indicate to terminal application 202 that the sequence of displayable characters 316 to be associated with metadata 310 has completed and that virtual terminal sequence 301 has completed. As shown in FIG. 3, end indicator 318 may comprise a non-displayable control code portion 320 (e.g., non-displayable escape character “ESC”). End indicator 318 may further comprise a second semantic sequence indicator 322. Second semantic sequence indicator 322 indicates to terminal application 202 that virtual terminal sequence 301 comprising semantic sequence 303 has completed. For example, as shown in FIG. 3, second semantic sequence indicator 322 comprises a ‘Q’ character followed by an ‘X’ character, which respectively corresponds to an ASCII encoding of 0x51 and 0x58 (and a Unicode encoding of U+0051 and U+0058). Second semantic sequence indicator 322 may be configured such that incompatible terminal applications ignore end indicator 318. For terminal applications that are not compatible with semantic sequences, such terminal applications attempt to interpret end indicator 318 as another virtual terminal sequence. However, because end indicator 318 comprises a sequence of characters (“QX”) that is unrecognizable to the incompatible terminal application, an incompatible terminal application will ignore end indicator 318.

It is noted that the usage of the ‘ESCQX’ characters is purely exemplary and that any sequence of one or more non-displayable and/or displayable characters may be used as end indicator 318. It is further noted that in certain embodiments, end indicator 318 may not be included in virtual terminal sequence 301. For instance, in accordance with an embodiment, delimiter 314 may further comprise a sequence of characters that specify a number of displayable characters 316 that are to be associated with metadata 310. In accordance with such an embodiment, end indicator 318 would not be required, as terminal application 202 may utilize the number specified by the delimiter to determine when the sequence of displayable characters 316 ends. For instance, in the example shown in FIG. 3, the delimiter may specify the number 10, which equates to the number of characters in displayable characters 316. After parsing the delimiter, semantic sequence parser 212 may count the number of characters processed subsequent to delimiter 314. When the number of characters reaches the number specified by the delimiter, semantic sequence parser 212 determines that no more displayable characters are to be associated with metadata 310.

It is noted that the order in which start indicator 302, first semantic sequence indicator 304, category indicator 306, start metadata indicator 308, metadata 310, end metadata indicator 312, delimiter 314, displayable characters 316, control code portion 320, and second semantic sequence indicator 322 are shown in sequence 300 is purely exemplary and that start indicator 302, first semantic sequence indicator 304, category indicator 306, start metadata indicator 308, metadata 310, end metadata indicator 312, delimiter 314, displayable characters 316, control code portion 320, and second semantic sequence indicator 322 may be ordered in a different fashion.

Referring again to FIG. 2, terminal application 202 receives the serialized stream of data from command line application 204 and stores the stream in input buffer 226. Rendering engine 228 parses the stream of data from input buffer 226 and may perform an action based thereon. For instance, upon parsing the stream of data and rendering engine 228 detects that the stream includes a displayable character, rendering engine 228 causes the displayable characters to be rendered via display device 214. As rendering engine 228 continues to parse the serialized stream of data, rendering engine 228 may detect a start indicator (e.g., start indicator 302) that indicates that the serialized stream of data includes a virtual terminal sequence. Upon detecting start indicator 302, rendering engine 228 may pass control to virtual terminal sequence parser 208 and cause virtual terminal sequence parser 208 to parse the serialized stream of data.

Virtual terminal sequence parser 208 may be configured to parse the virtual terminal sequence and perform an action corresponding to the virtual terminal sequence (e.g., change the foregoing and/or background colors, change the behavior of the cursor, etc.). In the event that virtual terminal sequence parser 208 determines that the virtual sequence comprises a semantic sequence indicator that indicates the start of a semantic sequence (e.g., first semantic sequence indicator 304), virtual terminal sequence parser 208 may pass to control to semantic sequence parser 212 and causes semantic sequence parser 212 to parse the serialized stream of data.

Semantic sequence parser 212 continues to parse the serialized stream of data and may detect a category indicator (e.g., category indicator 306) that indicates the category of metadata and/or displayable characters included in the semantic sequence and a start metadata indicator (e.g., start metadata indicator 308) that indicates that the characters following start metadata indicator 308 comprise metadata (e.g., metadata 310). Semantic sequence parser 212 may determine that each character subsequent to start metadata indicator 308 is metadata until semantic sequence parser 212 detects an end metadata indicator (e.g., end metadata indicator 312), which indicates that the semantic sequence no longer includes metadata.

As semantic sequence parser 212 continues to parse the serialized stream of data, semantic sequence parser 212 may detect a delimiter (e.g., delimiter 314) that indicates that the next portion of the serialized stream of data includes displayable characters and that the metadata is to be associated with such displayable characters. Thus, when parsing such a portion, semantic sequence parser 212 provides the detected displayable characters (e.g., displayable characters 316) to rendering engine 228, which renders displayable characters 316 to display device 214.

Semantic sequence parser 212 may associate metadata 310 with displayable characters in a dictionary 230. Dictionary 230 may comprise a data structure that hierarchically describes a user interface of terminal application 202 in which the displayable characters are displayed via display device 214. For instance, dictionary 230 may describe the hierarchical layout of the user interface. For example, dictionary 230 may specify that the user interface has one or more window panes, that the window pane(s) each comprise a ribbon, which in turn comprises a plurality of buttons. Dictionary 230 may also specify the locations (e.g., x-y coordinates) of the window pane(s), ribbons, buttons, etc. with respect to a display screen of display device 214. Dictionary 230 may further describe that each of the buttons in a particular ribbon has certain attributes (e.g., a name, a size, an associated icon, a color, etc.). Dictionary 230 may further hierarchically describe each of the entities represented by the characters displayed in each of the window pane(s). For instance, for a particular window pane, dictionary 230 may specify that the window pane displays a file list and the contents included therein. For instance, dictionary 230 may specify that the file list includes a plurality of files and/or folders, and specify contents of the files and/or the folders. For each of the file list entities, dictionary 230 may also specify attributes of such entities (e.g., one or more dates associated therewith, read/write permissions, etc.). Dictionary 230 may also specify the locations (e.g., x-y coordinates) at which the entities represented by the displayable characters are displayed with respect to a display screen of display device 214. For each of the entities represented by the displayable characters displayed in each of the window panes(s), dictionary 230 may also specify any metadata associated with the displayable characters as determined by semantic sequence parser 212.

Semantic sequence parser 212 continues to provide the detected displayable characters to rendering engine 228 until it detects an end indicator (e.g., end indicator 318), which indicates to semantic sequence parser 212 that the sequence of displayable characters 316 to be associated with metadata 310 has completed. End indicator 318 may also indicate to semantic sequence parser 212 that the semantic sequence has ended and may indicate to virtual terminal sequence parser 208 that the virtual terminal sequence that includes the semantic sequence has ended. Responsive to detecting end indicator 318, control is passed back to rendering engine 228, which continues to parse the serialized stream of data (if any more portions are stored in input buffer 226).

In accordance with an embodiment, terminal application 202 displays the metadata responsive to user input provided via input device(s) 216. For example, a user may hover a mouse cursor over certain displayable characters. In response to the cursor hovering over the displayable characters for a predetermined period of time, terminal application 202 may provide the coordinates at which the displayable characters are displayed with respect to the display screen of display device 214 and provide the coordinates to dictionary 230. Using the coordinates, dictionary 230 may determine the displayable characters located at the coordinates, along with the metadata associated with the displayable characters. Terminal application 202 may also obtain metadata associated with other entities associated with the entity for which the metadata describes in accordance with the hierarchy maintained by dictionary 230. For instance, a folder entity, may be associated with file entities included therein. Accordingly, the metadata for both the folder and the files included therein may be obtained. The determined metadata is provided to rendering engine 228, and rendering engine 228 may render the metadata onto the display screen of display device (e.g., in a box in proximity to the displayable characters).

In an embodiment, rendering engine 238 renders a first portion of the metadata responsive to first user input and renders a second portion of the metadata responsive to second user input. For instance, after hovering a mouse cursor over particular displayable characters, a user may press a key on a keyboard that cause rendering engine 228 to display the first portion of the metadata. For example, if the displayable characters represent a folder, the metadata displayed may be a listing of the files included therein. When a user presses the key a second time, rendering engine 228 may display additional metadata (e.g., the metadata associated with other entities associated with the entity represented by the particular displayable characters). For example, the metadata displayed may be the permissions for the files included in the folder.

In accordance with another embodiment, another application (e.g., application 232) may obtain the determined metadata and output the metadata in accordance with an outputting scheme supported by application 232. For instance, application 232 may comprise a screen reader application, a braille reader application, a machine-learning engine and/or any other application configured to parse, restructure, analyze, render and/or audibly read out data. In an example in which application 232 is a screen reader application, the screen reader application may be configured to audibly read the metadata out before, or in lieu of, audibly reading out the associated displayable characters, thereby providing the user with context as to what is being displayed on the screen. For example, if a directory listing is being displayed, for each folder and/or file displayed, metadata describing the folder and/or file may be audibly read out before reading out a name of the folder and/or file. For instance, the metadata may describe the entity type (e.g., “folder”, “file,”). Thus, when reading out displayable characters corresponding to a folder name, the screen reader application audibly read out “folder” first, followed by the folder name. In this way, a user will know what is being displayed on the display screen, rather than listening to a seemingly meaningless sequence of letters, numbers, names, etc.

In accordance with one or more embodiments, terminal application 202 and/or application 232 may obtain the metadata from dictionary 230 via an API call, such as a user interface automation (UTA) API call.

In accordance with one or more embodiments, the metadata included in a semantic sequence may comprise a data type of the entity. The associated displayable characters may be displayed in accordance with the data type. For instance, the displayable characters may be displayed in a first manner (e.g., in a first color, in a first format (e.g., bold, italicized, underlined, etc.), etc.) if the metadata specifies a first data type, and the displayable characters may be displayed in a second manner (e.g., in a second color, in a second format, etc.) if the metadata specifies a second data type.

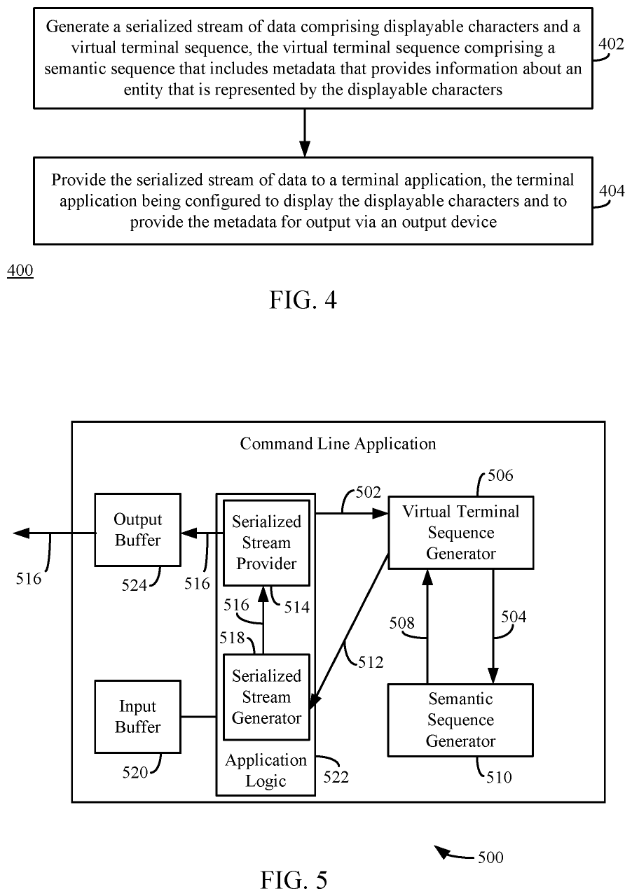

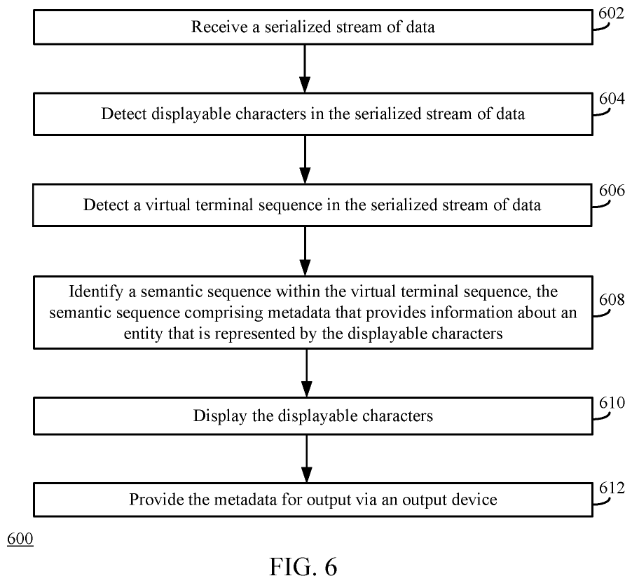

Accordingly, in example embodiments, context may be provided to characters displayed via a terminal application in various ways. For instance, FIG. 4 shows a flowchart 400 of a method for generating and providing a semantic sequence in accordance with an example embodiment. In an embodiment, flowchart 400 may be implemented by a command line application 500 shown in FIG. 5, although the method is not limited to that implementation. FIG. 5 shows a block diagram of a command line application 500 in accordance with an example embodiment. Command line application 500 is an example of command line application 204, as described above with reference to FIG. 2. As shown in FIG. 5, command line application 500 comprises a virtual terminal sequence generator 506, a semantic sequence generator 510, an input buffer 520, application logic 522, and an output buffer 524, which are examples of virtual terminal sequence generator 206, semantic sequence generator 210, input buffer 220, application logic 222, and output buffer 224, as respectively described above with reference to FIG. 2. Application logic 522 may comprise a serialized stream provider 514 and a serialized stream generator 418. Other structural and operational embodiments will be apparent to persons skilled in the relevant art(s) based on the discussion regarding flowchart 400 and command line application 500 of FIG. 5.

Flowchart 400 begins with step 402. In step 402, a serialized stream of data is generated that comprises displayable characters and a virtual terminal sequence. The virtual terminal sequence comprises a semantic sequence that includes metadata that provides information about an entity that is represented by the displayable characters. For example, with reference to FIG. 5, serialized stream generator 518 of application logic 522 may generate a serialized stream of data 516 that comprises displayable characters and a virtual terminal sequence. To generate the virtual terminal sequence, application logic 522 may issue an API call 502 to virtual terminal sequence generator 506. API call 502 may specify that a semantic sequence is to be generated, the particular string of displayable characters, and/or an abstracted version of the metadata to be associated with the displayable characters. In response to receiving API call 502, virtual terminal sequence generator 506 may issue an API call 504 to semantic sequence generator 510, which generates a semantic sequence (shown as semantic sequence 508) that associates the displayable characters with the metadata and provides semantic sequence 508 to virtual terminal sequence generator 506. Virtual terminal sequence generator 506 generates a virtual terminal sequence (shown as virtual terminal sequence 512) that includes semantic sequence 508. Virtual terminal sequence 512 is provided to application logic 522. Serialized stream generator 518 of application logic 522 may convert virtual terminal sequence 512 to serialized stream of data 516 and provides serialized stream of data 516 to serialized stream provider 514.

In accordance with one or more embodiments, the entity comprises at least one of a file, a folder, a date associated with at least one of the file or the folder, one or more permissions associated with at least one of the file or the folder, or a size associated with at least one of the file or the folder.

In accordance with one or more embodiments, the virtual terminal sequence generator is configured to insert a start indicator that indicates to the terminal application that a subsequent portion of the semantic sequence comprises the metadata. For example, with reference to FIG. 5, virtual terminal sequence generator 506 is configured to insert a start indicator (e.g., indicators 302 and/or 304, as shown in FIG. 3) that indicates to a terminal application (e.g., terminal application 202, as shown in FIG. 2) that a subsequent portion of the semantic sequence (e.g., semantic sequence 303, as shown in FIG. 3) comprises the metadata (e.g., metadata 310, as shown in FIG. 3). In accordance with one or more embodiments, the virtual terminal sequence generator is configured to insert an end indicator that indicates to the terminal application an end to the semantic sequence. For example, with reference to FIG. 5, virtual terminal sequence generator 506 is configured to insert an end indicator (e.g., indicator 318, as shown in FIG. 3) that indicates to a terminal application an end to the semantic sequence.

In accordance with one or more embodiments, the start indicator and the end indicator are non-displayable characters (e.g., non-displayable control code).

In accordance with one or more embodiments, the semantic sequence generator is configured to insert a delimiter subsequent to the metadata that causes the terminal application to associate the metadata with the displayable characters. For example, with reference to FIG. 3, semantic sequence generator 510 inserts a delimiter (e.g., delimiter 314, as shown in FIG. 3) subsequent to the metadata (e.g., metadata 310, as shown in FIG. 3) that indicates, to the terminal application that causes the terminal application to associate the metadata with the displayable characters (e.g., displayable characters 316).

In accordance with one or embodiments, the delimiter further indicates a number of the displayable characters that are to be associated with the metadata.

In accordance with one or more embodiments, the metadata comprises a data type of the entity, and a manner in which the the displayable characters that represents the entity are presented (e.g., by the terminal application) is based on the data type.

In step 404, the serialized stream of data is provided to a terminal application, the terminal application being configured to display the displayable characters and to provide the metadata for output via an output device. For example, with reference to FIG. 5, serialized stream provider 514 provides serialized stream of data 516 that includes virtual terminal sequence 512 to output buffer 524, which buffers serialized stream of data 516 for output as a serialized stream of data to a terminal application 202.

The terminal application may receive the serialized stream of data and parse the stream for virtual terminal sequences and/or semantic sequences included therein. As described above, the semantic sequences may be utilized to provide context for characters displayed by the terminal application.

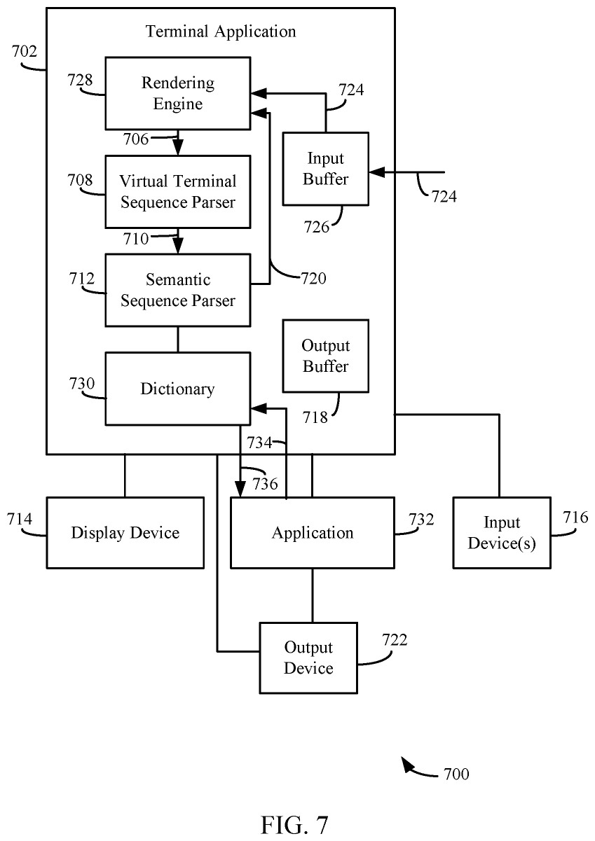

For example, FIG. 6 shows a flowchart 600 of a method for providing context to characters displayed by a terminal application in accordance with an example embodiment. In an embodiment, flowchart 600 may be implemented by a terminal application 702 shown in FIG. 7, although the method is not limited to that implementation. FIG. 7 shows a block diagram of a system 700 for providing context to characters displayed by a terminal application 702 in accordance with an example embodiment. System 700 comprises terminal application 702, input device(s) 716, a display device 714, an application 732, and an output device 722. Terminal application 702, display device 714, application 732, and input device(s) 716 are examples of example of terminal application 202, display device 214, application 232, and input device(s) 216, as described above with reference to FIG. 2. As shown in FIG. 7, terminal application 704 comprises an input buffer 726, an output buffer 718, a rendering engine 728, a virtual terminal sequence parser 708, a semantic sequence parser 712, and a dictionary 730. Input buffer 726, output buffer 718, rendering engine 728, virtual terminal sequence parser 708, semantic sequence parser 712, and dictionary 730 are examples of input buffer 226, output buffer 218, rendering engine 228, virtual terminal sequence parser 208, semantic sequence parser 212, and dictionary 230, as respectively described above with reference to FIG. 2. Other structural and operational embodiments will be apparent to persons skilled in the relevant art(s) based on the discussion regarding flowchart 600 and system 700 of FIG. 7.

Flowchart 600 begins with step 602. In step 602, a serialized stream of data is received. For example, with reference to FIG. 7, terminal application 704 receives a serialized stream of data 724. Serialized stream of data 724 is an example of serialized stream of data 516, as described above with reference to FIG. 5. Serialized stream of data 724 may be stored in input buffer 726.

In step 604, displayable characters in the serialized stream of data are detected. For example, with reference to FIG. 7, rendering engine 728 retrieves serialized stream of data 724, parses serialized stream of data 724, and detects displayable characters included therein.

In step 606, a virtual terminal sequence in the serialized stream of data is detected. For example, with reference to FIG. 7, rendering engine 728 may detect a virtual terminal sequence in serialized stream of data 724. In response, rendering engine 728 may provide a control signal 706 to virtual terminal sequence parser 708, which indicates that serialized stream of data 724 includes a virtual terminal sequence (e.g., virtual terminal sequence 301, as shown in FIG. 3) and also passes parsing operations to virtual terminal sequence parser 708.

In step 608, a semantic sequence within the virtual terminal sequence is identified. The semantic sequence comprises metadata that provides information about an entity that is represented by the displayable characters. For example, with reference to FIG. 7, virtual terminal sequence parser 708 may detect that the virtual terminal sequence comprises a semantic sequence. In response, virtual terminal sequence parser 708 may provide a control signal 710 to semantic sequence parser 712, which indicates that the virtual terminal sequence includes a semantic sequence (e.g., semantic sequence 303, as shown in FIG. 3) and also passes parsing operations to semantic sequence parser 712. Semantic sequence parser 712 may continue to parse serialized stream of data 724 and identify the metadata (e.g., metadata 310) that provides information about an entity represented by the displayable characters (e.g., displayable characters 316).

In accordance with one or more embodiments, the entity comprises at least one of a file, a folder, a date associated with at least one of the file or the folder, one or more permissions associated with at least one of the file or the folder, or a size associated with at least one of the file or the folder.

In accordance with one or more embodiments, the metadata comprises a data type of the entity, and wherein a manner in which the displayable characters that represent the entity are presented is based on the data type.

In accordance with one or more embodiments, the semantic sequence comprises a start indicator that indicates to the terminal application that a subsequent portion of the semantic sequence comprises the metadata. For example, with reference to FIG. 7, the semantic sequence comprises a start indicator that indicates to semantic sequence parser 712 of terminal application 702 that a subsequent portion of the semantic sequence (e.g., semantic sequence 303, as shown in FIG. 3) comprises the metadata (e.g., metadata 310, as shown in FIG. 3).

In accordance with one or more embodiments, the semantic sequence comprises an end indicator that indicates to the terminal application an end to the semantic sequence. For example, with reference to FIG. 7, the semantic sequence comprises an end indicator 318 that indicates to semantic sequence parser 712 of terminal application 702 an end to the semantic sequence (e.g., semantic sequence 303, as shown in FIG. 3).

In accordance with one or more embodiments, the start indicator and the end indicator are non-displayable characters (e.g., non-displayable control code).

In accordance with one or more embodiments, the semantic sequence further comprises a delimiter that causes the terminal application to associate the metadata with the displayable characters. For example, with reference to FIG. 7, the semantic sequence (e.g., semantic sequence 303, as shown in FIG. 3) comprises a delimiter (e.g., delimiter 314) that causes semantic sequence parser 212 to associate the metadata with the displayable characters.

In accordance with one or embodiments, the delimiter further indicates a number of the displayable characters that are to be associated with the metadata.

In accordance with one or more embodiments, semantic sequence parser 712 may store the metadata in a data structure that hierarchically describes entities in a user interface of the terminal application in which the displayable characters are displayed. For instance, with reference to FIG. 7, semantic sequence parser 712 may store the metadata in dictionary 730, which hierarchically describes entities in a user interface of terminal application 702 in which the displayable characters are displayed.

In step 610, the displayable characters are displayed. For instance, with reference to FIG. 6, semantic sequence parser 612 may provide the detected displayable characters (shown as displayable characters 720 in FIG. 7) to rendering engine 628, which renders displayable characters 720 to display device 714.

In step 612, the metadata is provided for output via an output device. For example, with reference to FIG. 7, terminal application 702 may provide the metadata for output via output device 722. Output device 722 may be comprise a monitor, a television, a projector, a speaker, etc. It is noted that output device 722 may be incorporated with display device 714.

In accordance with one or more embodiments, the metadata is provided to a software application. The software application is configured to read the metadata from the data structure and output the metadata via the output device responsive to user interaction with the displayable characters associated with the metadata. For example, with reference to FIG. 7, the metadata is provided to application 732. Application 732 may be configured to read the metadata from dictionary 730 and output the metadata via output device 722 responsive to user interaction with the displayable characters (rendered on display device 714) associated with the metadata. For instance, application 732 may issue an API call 734 (e.g., a UIA API call) to dictionary 730. In response, dictionary 730 may provide the metadata (shown as metadata 736) to application 732.

In accordance with one or more embodiments, the software application is a screen reader application configured to audibly read out the metadata via the output device. For example, with reference to FIG. 7, application 732 is a screen reader application configured to audibly read out the metadata via output device 722 (e.g., a speaker).

In accordance with one or more embodiments, the software application is terminal application 702. For instance, terminal application 702 may issue an API call (e.g., a UIA API call) to dictionary 730 to retrieve the metadata and display the metadata in response to user interaction with displayable characters 720.

In accordance with one or more embodiments, the metadata is provided to a screen reader application, the screen reader being configured to audibly read out the metadata via the output device responsive to user interaction with at least one of the file, the folder, the date, the one or more permissions, or the size.

III. Example Mobile Device Implementation

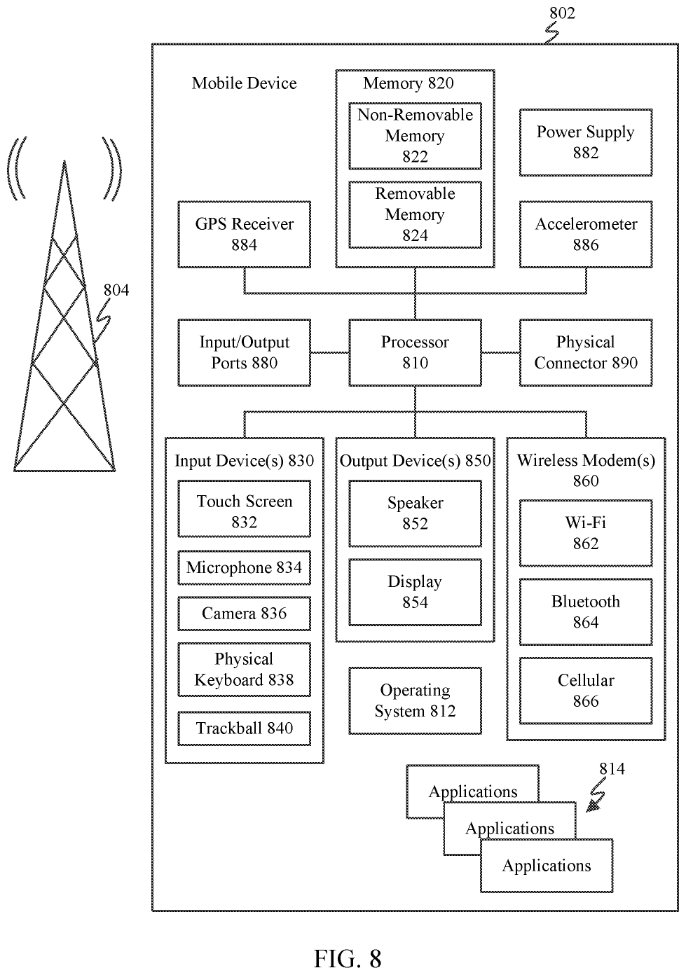

FIG. 8 is a block diagram of an exemplary mobile device 802 that may implement embodiments described herein. For example, mobile device 802 may be used to implement terminal application 102, command line application 104, display device 114 and/or input device(s) 116 of FIG. 1, terminal application 202, command line application 204, display device 214, application 232, and/or input device(s) 216 of FIG. 2, command line application 500 of FIG. 5, terminal application 702, display device 714, application 732, input device(s) 716, and/or output device 722 of FIG. 7, and/or any of the components respectively described therein. As shown in FIG. 8, mobile device 802 includes a variety of optional hardware and software components. Any component in mobile device 802 can communicate with any other component, although not all connections are shown for ease of illustration. Mobile device 802 can be any of a variety of computing devices (e.g., cell phone, smart phone, handheld computer, Personal Digital Assistant (PDA), etc.) and can allow wireless two-way communications with one or more mobile communications networks 804, such as a cellular or satellite network, or with a local area or wide area network. Mobile device 802 can also be any of a variety of wearable computing device (e.g., a smart watch, an augmented reality headset, etc.).

Mobile device 802 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components of mobile device 802 and provide support for one or more application programs 814 (also referred to as “applications” or “apps”). Application programs 814 may include common mobile computing applications (e.g., e-mail applications, calendars, contact managers, web browsers, messaging applications) and any other computing applications (e.g., word processing applications, mapping applications, media player applications).

Mobile device 802 can include memory 820. Memory 820 can include non-removable memory 822 and/or removable memory 824. Non-removable memory 822 can include RAM, ROM, flash memory, a hard disk, or other well-known memory devices or technologies. Removable memory 824 can include flash memory or a Subscriber Identity Module (SIM) card, which is well known in GSM communication systems, or other well-known memory devices or technologies, such as “smart cards.” Memory 820 can be used for storing data and/or code for running operating system 812 and application programs 814. Example data can include web pages, text, images, sound files, video data, or other data to be sent to and/or received from one or more network servers or other devices via one or more wired or wireless networks. Memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 802 can support one or more input devices 830 (which may be examples of input device(s) 116, input device(s) 216, and input device(s) 716), such as a touch screen 832, a microphone 834, a camera 836, a physical keyboard 838 and/or a trackball 840 and one or more output devices 850 (which may examples of output device(s) 722 and/or display device 114, display device 214, and/or display device 714), such as a speaker 852 and a display 854. Other possible output devices (not shown) can include piezoelectric or other haptic output devices. Some devices can serve more than one input/output function. For example, touch screen 832 and display 854 can be combined in a single input/output device. Input devices 830 can include a Natural User Interface (NUI).

Wireless modem(s) 860 can be coupled to antenna(s) (not shown) and can support two-way communications between processor 810 and external devices, as is well understood in the art. Modem(s) 860 are shown generically and can include a cellular modem 866 for communicating with the mobile communication network 804 and/or other radio-based modems (e.g., Bluetooth 864 and/or Wi-Fi 862). At least one of wireless modem(s) 860 is typically configured for communication with one or more cellular networks, such as a GSM network for data and voice communications within a single cellular network, between cellular networks, or between the mobile device and a public switched telephone network (PSTN).

Mobile device 802 can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components of mobile device 802 are not required or all-inclusive, as any components can be deleted and other components can be added as would be recognized by one skilled in the art.

In an embodiment, mobile device 802 is configured to implement any of the above-described features of terminal application 102, command line application 104, display device 114 and/or input device(s) 116 of FIG. 1, terminal application 202, command line application 204, display device 214, application 232, and/or input device(s) 216 of FIG. 2, command line application 500 of FIG. 5, terminal application 702, display device 714, application 732, input device(s) 716, and/or output device 722 of FIG. 7, and/or any of the components respectively described therein. Computer program logic for performing the functions of these devices may be stored in memory 820 and executed by processor 810.

IV. Example Computer System Implementation

FIG. 9 depicts an example processor-based computer system 900 that may be used to implement various embodiments described herein. For example, system 900 may be used to implement terminal application 102, command line application 104, display device 114 and/or input device(s) 116 of FIG. 1, terminal application 202, command line application 204, display device 214, application 232, and/or input device(s) 216 of FIG. 2, command line application 500 of FIG. 5, terminal application 702, display device 714, application 732, input device(s) 716, and/or output device 722 of FIG. 7, and/or any of the components respectively described therein. System 900 may also be used to implement any of the steps of any of the flowcharts of FIGS. 4 and 6, as described above. The description of system 900 provided herein is provided for purposes of illustration, and is not intended to be limiting. Embodiments may be implemented in further types of computer systems, as would be known to persons skilled in the relevant art(s).

As shown in FIG. 9, system 900 includes a processing unit 902, a system memory 904, and a bus 906 that couples various system components including system memory 904 to processing unit 902. Processing unit 902 may comprise one or more circuits, microprocessors or microprocessor cores. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

System 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, BLU-RAY™ disk or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 930, one or more application programs 932, other program modules 934, and program data 936. In accordance with various embodiments, the program modules may include computer program logic that is executable by processing unit 902 to perform any or all of the functions and features of terminal application 102, command line application 104, display device 114 and/or input device(s) 116 of FIG. 1, terminal application 202, command line application 204, display device 214, application 232, and/or input device(s) 216 of FIG. 2, command line application 500 of FIG. 5, terminal application 702, display device 714, application 732, input device(s) 716, and/or output device 722 of FIG. 7, and/or any of the components respectively described therein. The program modules may also include computer program logic that, when executed by processing unit 902, causes processing unit 902 to perform any of the steps of any of the flowcharts of FIGS. 4 and 6, as described above.

A user may enter commands and information into system 900 through input devices such as a keyboard 938 and a pointing device 940 (e.g., a mouse) (which may examples of input device(s) 116, input device(s) 216, and input device(s) 716). Other input devices (not shown) may include a microphone, joystick, game controller, scanner, or the like. In one embodiment, a touch screen is provided in conjunction with a display 944 (which may be an example of output device(s) 722 and/or display device 114, display device 214, and/or display device 714) to allow a user to provide user input via the application of a touch (as by a finger or stylus for example) to one or more points on the touch screen. These and other input devices are often connected to processing unit 902 through a serial port interface 942 that is coupled to bus 906, but may be connected by other interfaces, such as a parallel port, game port, or a universal serial bus (USB). Such interfaces may be wired or wireless interfaces.

Display 944 is connected to bus 906 via an interface, such as a video adapter 946. In addition to display 944, system 900 may include other peripheral output devices (not shown) such as speakers and printers.

System 900 is connected to a network 948 (e.g., a local area network or wide area network such as the Internet) through a network interface 950, a modem 952, or other suitable means for establishing communications over the network. Modem 952, which may be internal or external, is connected to bus 906 via serial port interface 942.

As used herein, the terms “computer program medium,” “computer-readable medium,” and “computer-readable storage medium” are used to generally refer to memory devices or storage structures such as the hard disk associated with hard disk drive 914, removable magnetic disk 918, removable optical disk 922, as well as other memory devices or storage structures such as flash memory cards, digital video disks, random access memories (RAMs), read only memories (ROM), and the like. Such computer-readable storage media are distinguished from and non-overlapping with communication media (do not include communication media or modulated data signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 932 and other program modules 934) may be stored on the hard disk, magnetic disk, optical disk, ROM, or RAM. Such computer programs may also be received via network interface 950, serial port interface 942, or any other interface type. Such computer programs, when executed or loaded by an application, enable system 900 to implement features of embodiments discussed herein. Accordingly, such computer programs represent controllers of the system 900. Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 900 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### V. Additional Example Embodiments

A method by a terminal application executing on a computing device is described herein. The method includes: receiving a serialized stream of data; detecting displayable characters in the serialized stream of data; detecting a virtual terminal sequence in the serialized stream of data; identifying a semantic sequence within the virtual terminal sequence, the semantic sequence comprising metadata that provides information about an entity that is represented by the displayable characters; displaying the displayable characters; and providing the metadata for output via an output device.

In one implementation of the foregoing method, the semantic sequence comprises: a start indicator that indicates to the terminal application that a subsequent portion of the semantic sequence comprises the metadata.

In another implementation of the foregoing method, the semantic sequence further comprises: an end indicator that indicates to the terminal application an end to the semantic sequence.

In another implementation of the foregoing method, the start indicator and the end indicator are non-displayable characters.

In another implementation of the foregoing method, the semantic sequence further comprises: a delimiter that causes the terminal application to associate the metadata with the displayable characters.

In another implementation of the foregoing method, the delimiter further indicates a number of the displayable characters that are to be associated with the metadata.

In another implementation of the foregoing method, the method further includes storing the metadata in a data structure that hierarchically describes entities in a user interface of the terminal application in which the displayable characters are displayed.

In another implementation of the foregoing method, said providing comprises: providing the metadata to a software application, the software application being configured to read the metadata from the data structure and output the metadata via the output device responsive to user interaction with the displayable characters associated with the metadata.

In another implementation of the foregoing method, the software application is a screen reader application configured to audibly read out the metadata via the output device.

In another implementation of the foregoing method, the metadata comprises a data type of the entity, and wherein a manner in which the displayable characters that represent the entity are presented is based on the data type.

In another implementation of the foregoing method, the entity comprises at least one of: a file; a folder; a date associated with at least one of the file or the folder; one or more permissions associated with at least one of the file or the folder; or a size associated with at least one of the file or the folder.

In another implementation of the foregoing method, said providing comprises: providing the metadata to a screen reader application, the screen reader being configured to audibly read out the metadata via the output device responsive to user interaction with at least one of the file, the folder, the date, the one or more permissions, or the size.

A computing device is also described herein. The computing device includes: at least one processor circuit; and at least one memory that stores program code configured to be executed by the at least one processor circuit, the program code comprising: a virtual terminal sequence generator configured to: generate a serialized stream of data comprising displayable characters and a virtual terminal sequence, the virtual terminal sequence comprising a semantic sequence that includes metadata that provides information about an entity that is represented by the displayable characters; and a virtual terminal sequence provider configured to: provide the serialized stream of data to a terminal application, the terminal application being configured to display the displayable characters and to provide the metadata for output via an output device.

In one implementation of the foregoing computing device, the virtual terminal sequence generator is configured to: insert a start indicator that indicates to the terminal application that a subsequent portion of the semantic sequence comprises the metadata.

In another implementation of the foregoing computing device, the virtual terminal sequence generator is further configured to: insert an end indicator that indicates to the terminal application an end to the semantic sequence.

In another implementation of the foregoing computing device, the start indicator and the end indicator are non-displayable characters.

In another implementation of the foregoing computing device, the program code further comprises a semantic sequence generator configured to: insert a delimiter subsequent to the metadata that causes the terminal application to associate the metadata with the displayable characters.

In another implementation of the foregoing computing device, the delimiter further indicates a number of the displayable characters that are to be associated with the metadata.

A computer-readable storage medium having program instructions recorded thereon that, when executed by at least one processor, perform a method. The method includes: receiving a serialized stream of data; detecting displayable characters in the serialized stream of data; detecting a virtual terminal sequence in the serialized stream of data; identifying a semantic sequence within the virtual terminal sequence, the semantic sequence comprising metadata that provides information about an entity that is represented by the displayable characters; displaying the displayable characters; and providing the metadata for output via an output device.

In another implementation of the foregoing computer-readable storage medium, the entity comprises at least one of: a file; a folder; a date associated with at least one of the file or the folder; one or more permissions associated with at least one of the file or the folder; or a size associated with at least one of the file or the folder.

### VI. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the present invention should not be limited by any of the above-described example embodiments, but should be defined only in accordance with the following claims and their equivalents.

What is claimed is:

1. A method implemented by a terminal application executing on a computing device, comprising:
receiving a serialized stream of data;
detecting displayable characters in the serialized stream of data;
detecting a virtual terminal sequence in the serialized stream of data;
identifying a semantic sequence within the virtual terminal sequence, the semantic sequence comprising metadata that provides information about an entity that is represented by the displayable characters;
displaying the displayable characters; and
providing the metadata for output via an output device.

2. The method of claim 1, wherein the semantic sequence comprises:
a start indicator that indicates to the terminal application that a subsequent portion of the semantic sequence comprises the metadata.

3. The method of claim 2, wherein the semantic sequence further comprises:
an end indicator that indicates to the terminal application an end to the semantic sequence.

4. The method of claim 3, wherein the start indicator and the end indicator are non-displayable characters.

5. The method of claim 1, wherein the semantic sequence further comprises:
a delimiter that causes the terminal application to associate the metadata with the displayable characters.

6. The method of claim 5, wherein the delimiter further indicates a number of the displayable characters that are to be associated with the metadata.

7. The method of claim 1, further comprising:
storing the metadata in a data structure that hierarchically describes entities in a user interface of the terminal application in which the displayable characters are displayed.

8. The method of claim 7, wherein said providing comprises:
providing the metadata to a software application, the software application being configured to read the metadata from the data structure and output the metadata via the output device responsive to user interaction with the displayable characters associated with the metadata.

9. The method of claim 8, wherein the software application is a screen reader application configured to audibly read out the metadata via the output device.

10. The method of claim 1, wherein the metadata comprises a data type of the entity, and wherein a manner in which the displayable characters that represent the entity are presented is based on the data type.

11. The method of claim 1, wherein the entity comprises at least one of:
a file;
a folder;
a date associated with at least one of the file or the folder;
one or more permissions associated with at least one of the file or the folder; or
a size associated with at least one of the file or the folder.

12. The method of claim 11, wherein said providing comprises:
providing the metadata to a screen reader application, the screen reader being configured to audibly read out the metadata via the output device responsive to user interaction with at least one of the file, the folder, the date, the one or more permissions, or the size.

13. A computing device, comprising:
at least one processor circuit; and
at least one memory that stores program code configured to be executed by the at least one processor circuit, the program code comprising:
a serialized stream generator configured to:
generate a serialized stream of data comprising displayable characters and a virtual terminal sequence, the virtual terminal sequence comprising a semantic sequence that includes metadata that provides information about an entity that is represented by the displayable characters; and
a serialized stream provider configured to:
provide the serialized stream of data to a terminal application, the terminal application being configured to display the displayable characters and to provide the metadata for output via an output device.

14. The computing device of claim 13, wherein the virtual terminal sequence generator is configured to:
insert a start indicator that indicates to the terminal application that a subsequent portion of the semantic sequence comprises the metadata.

15. The computing device of claim 14, wherein the virtual terminal sequence generator is further configured to:
insert an end indicator that indicates to the terminal application an end to the semantic sequence.

16. The computing device of claim 15, wherein the start indicator and the end indicator are non-displayable characters.

17. The computing device of claim 13, wherein the program code further comprises a semantic sequence generator configured to:
insert a delimiter subsequent to the metadata that causes the terminal application to associate the metadata with the displayable characters.

18. The computing device of claim 17, wherein the delimiter further indicates a number of the displayable characters that are to be associated with the metadata.

19. A computer-readable storage medium having program instructions recorded thereon that, when executed by at least one processor, perform a method, the method comprising:
receiving a serialized stream of data;
detecting displayable characters in the serialized stream of data;
detecting a virtual terminal sequence in the serialized stream of data;
identifying a semantic sequence within the virtual terminal sequence, the semantic sequence comprising metadata that provides information about an entity that is represented by the displayable characters;
displaying the displayable characters; and
providing the metadata for output via an output device.

20. The computer-readable storage medium of claim 19, wherein the entity comprises at least one of:
a file;
a folder;
a date associated with at least one of the file or the folder;
one or more permissions associated with at least one of the file or the folder; or
a size associated with at least one of the file or the folder.
